(19) United States
(12) Patent Application Publication
(10) Pub. No.: US 2025/0318521 A1
(43) Pub. Date: Oct. 16, 2025

(54) COMBINATION FOR REDUCING PHYTOTOXICITY OF SYSTEMIC FUNGICIDES IN CROPS AND RELATED METHODS

(71) Applicant: UPL Mauritius Limited, Port Louis (MU)

(72) Inventors: Evan PERKINS, Durham, NC (US); Hendrik Leonard YPEMA, Durham, NC (US)

(21) Appl. No.: 19/175,458

(22) Filed: Apr. 10, 2025

Related U.S. Application Data
(60) Provisional application No. 63/632,661, filed on Apr. 11, 2024.

(51) Int. Cl. A01N 25/32; A01N 43/653; A01P 3/00

(52) U.S. Cl. CPC A01N 25/32; A01N 43/653; A01P 3/00

(57) ABSTRACT

The present disclosure provides a safener for reducing phytotoxicity of systemic fungicides in field applications. The present disclosure also provides an agrochemical combination comprising a safener compound and a triazole fungicide. The present disclosure further provides a method of applying a safener for reducing phytotoxicity in crops.

### TECHNICAL FIELD

The present disclosure provides a safener for reducing phytotoxicity of systemic fungicides in field applications. The present disclosure also provides an agrochemical combination comprising a safener compound and a triazole fungicide. The present disclosure further provides a method of applying a safener for reducing phytotoxicity in crops.

### BACKGROUND

Triazole fungicides are widely applied in crop cultivations to protect plants against fungal infestation. Triazole fungicides are inhibitors of lanosterol 14α-demethylase, which is essential for biosynthesis of ergosterol, a key fungal cell membrane component, thus inhibiting fungal growth. Triazoles may influence the biochemical processes in plants and other non-target species as well.

Triazole fungicides can cause phytotoxic damage to the plant itself when applied in amounts normally required to provide adequate control against fungal diseases. Symptoms of phytotoxic damage may be observed on the plant at emergence or during its growth or may be expressed at harvest and may be temporary or lasting. Triazoles can vary in their effects resulting in phytotoxicity and the level of injury depends on the fungicide rate, adjuvants used, plant genetics and environmental conditions at the time of application.

Fungicide phytotoxicity, also known as triazole injury, can occasionally occur on soybean following the application of a foliar fungicide that contains an active ingredient in the demethylation inhibitor (DMI), or triazole fungicide class. The mechanism of the fungicide causing the plant injury is not known, but symptoms are most likely to manifest in the upper canopy 21-28 days after application. It typically appears as interveinal chlorosis, characterized by the yellowing of tissue between the leaf veins. In severe cases, the leaf tissue between the veins may turn necrotic, or brown, and die. These symptoms can be mistaken for those of several soybean diseases, including red crown rot, Frogeye leaf spot (FLS), and sudden death syndrome (SDS).

PCT Publication No. WO2007/093535 discloses a method of using a micronutrient selected from the group consisting of salts and adducts of Mg, Ca, B, Mn, Fe, Co, Zn and Mo as a safener for a triazole for controlling harmful fungi. The micronutrient demonstrated to be used here is selected from the group consisting of mancozeb, maneb, metiram, propineb, zineb and ziram.

PCT Publication No. WO2016/090446 discloses a method for reducing the phytotoxicity of systemic fungicides, mainly triazoles, in susceptible cultivars, mainly soy cultivars. WO′446 discloses a method of reducing phytotoxicity of a fungicidal combination consisting of tebuconazole or prothioconazole and a strobilurin fungicide in soybean cultivars, the method comprising applying a homogenized syrup comprising mancozeb and premixed tebuconazole or prothioconazole and strobilurin fungicide to top leaves of a soybean crop, wherein adding mancozeb to the fungicidal combination consisting of tebuconazole or prothioconazole and a strobilurin fungicide decreases the phytotoxicity of the tebuconazole or prothioconazole to the soybean crop in comparison to a method lacking adding mancozeb.

A safener is usually applied as a tank mix with an agrochemical, generally a herbicide or a fungicide. The application becomes tedious since it involves appropriately solubilizing the safener in water, followed by spraying. Therefore, there is a need for a safener which has agrochemical attributes and is soluble in water.

Prior art literature focusses on application of mancozeb as the ‘micronutrient’ component in reducing phytotoxicity of triazole fungicides.

There is a need to arrive at a novel and improved safening formulation for the reduction of phytotoxicity caused by triazole fungicide without compromising the fungicidal activity. Surprisingly, the inventors of the present disclosure pioneered a novel and eco-friendly safener for reducing phytotoxicity of systemic fungicides.

### Object

It is an object of the present disclosure to provide a safe, cost-efficient, eco-friendly safener for reducing phytotoxicity of systemic fungicides.

It is an object of the present disclosure to provide a safener for significantly reducing phytotoxicity of triazole fungicides compared to conventionally used micronutrient safeners.

It is an object of the present disclosure to provide a micronutrient safener for reducing phytotoxicity of triazole fungicides.

It is another object of the present disclosure to provide an agrochemical combination comprising a safening amount of a micronutrient and a fungicidally effective amount of a triazole fungicide.

It is another object of the present disclosure to provide a method for reducing phytotoxicity of triazole fungicides by applying at a locus of a plant or a plant part or a plant propagation material a safener together with one or more triazole fungicides and an additional agrochemical.

It is yet another object of the present disclosure to provide a method for controlling phytopathogenic fungi by applying a micronutrient and triazole fungicides.

### SUMMARY

The present disclosure provides a safener for reducing phytotoxicity of systemic fungicides.

The present disclosure provides a safener for reducing phytotoxicity of triazole fungicides.

In an aspect, the present disclosure provides a safener comprising a zinc salt of a nitrogen containing compound for reducing phytotoxicity of triazole fungicides, wherein the concentration of zinc is ranging from 5% to 30% by weight of the nitrogen containing compound.

In an aspect, the present disclosure provides a safener comprising a zinc salt of a nitrogen containing compound for reducing phytotoxicity of triazole fungicides, wherein the concentration of zinc is ranging from 10% to 20% by weight of the nitrogen containing compound.

In an aspect, the present disclosure provides a safener comprising a zinc salt of a nitrogen containing compound for reducing phytotoxicity of triazole fungicides, wherein the concentration of zinc is ranging from 10% to 15% by weight of the nitrogen containing compound.

In an aspect, the zinc salt of a nitrogen containing compound is an agrochemical.

In another aspect, the agrochemical is a chelating compound.

In an aspect, the chelating compound is a zinc salt of ethylenediaminetetraacetic acid (EDTA).

In another aspect, the present disclosure provides an agrochemical combination comprising a zinc salt of a nitrogen containing compound and a triazole fungicide.

In another aspect, the present disclosure provides an agrochemical combination comprising a chelating compound and a triazole fungicide.

In another aspect, the present disclosure provides an agrochemical combination comprising a zinc salt of ethylenediaminetetraacetic acid (EDTA) and a triazole fungicide.

In another aspect, the present disclosure provides a method for reducing phytotoxicity of triazole fungicides in crops, comprising applying a zinc salt of a nitrogen containing compound, wherein the concentration of zinc is ranging from 5% to 30% by weight of the nitrogen containing compound.

In another aspect, the present disclosure provides a method for reducing phytotoxicity of triazole fungicides in crops, comprising applying a zinc salt of a chelating compound, wherein the concentration of zinc is ranging from 5% to 30% by weight of the nitrogen containing compound.

In yet another aspect, the present disclosure provides a method for reducing phytotoxicity of triazole fungicides in crops, comprising applying a zinc salt of EDTA, wherein the concentration of zinc is ranging from 5% to 30% by weight of the nitrogen containing compound.

Advantageously, the present disclosure provides a safe, cost-efficient, eco-friendly safener and effective for reducing phytotoxicity of triazole fungicides.

### DETAILED DESCRIPTION

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from essence of the invention disclosed. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

It must be noted that, as used in this specification, the singular forms “a,” “an” and “the” include plural referents unless the content clearly dictates otherwise. The terms first, second etc., as used herein are not meant to denote any particular ordering, but simply for convenience to denote a plurality of, for example, layers. The terms “preferred” and “preferably” refer to embodiments of the disclosure that may afford certain benefits, under certain circumstances.

As used herein, the terms “comprising” “including,” “having,” “containing,” “involving,” and the like are to be understood to be open-ended, i.e., to mean including but not limited to.

As used herein, the term “about” or “approximately” is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +10% or +5% of the stated value.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

The use of any examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

While the disclosure has been described with reference to an exemplary embodiment, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

As used herein, the expression of various quantities in terms of “%” or “% w/v” or “% w/w” means the percentage by weight of the total solution or composition unless otherwise specified.

As used herein, the term “agrochemical” refers to an agricultural chemical such as pesticides, fungicides, insecticides, acaricides, herbicides, nematicides, plant growth regulators and can be used interchangeably.

As used herein, the term “agrochemically acceptable salt” means a salt which is acceptable for use in agrochemical or horticultural use. The salts referred to herein are agrochemically acceptable salts.

As used herein, the term “fungicide” denotes a compound which controls or modifies the growth of fungus.

As used herein, the term “fungicidal” refers to the ability of a substance to control or modify the growth of fungus or its spores.

As used herein, the term “fungicidally effective amount” indicates the quantity of such a compound or combination of such compounds which is capable of controlling or modifying the growth of the fungus. The terms “effective amount” or “agriculturally acceptable effective amount”, refer to an amount of an active ingredient, such as in the disclosed combination(s), which has an adverse effect on a fungus, treats or prevents a fungal disease in a plant, and is not significantly toxic to the plant being treated. The adverse effect can include killing of the fungus (fungicidal), preventing growth of the fungus, blocking of biosynthetic pathway(s), or a combination thereof.

As used herein, the term “control” or “disease control” refers to the treatment and/or prevention of a disease, and specifically, a fungal disease. Controlling effects include any and all deviations from the natural development of the disease, for example: killing of the fungal agent, retardation of disease development, and decrease in amount or degree of the fungal disease.

As used herein, the term “plant(s)” or “crop(s)” refers to the physical parts of a plant, including for example, seeds, seedlings, saplings, roots, tubers, stems, stalks, foliage, and fruits. This term also encompasses plant crops such as fruits. The term “plant” is limited to a living plant organism which expresses a set of characteristics determined by its single, genetic makeup or genotype, which can be duplicated through asexual reproduction, but which cannot otherwise be “made” or “manufactured.

The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein, the term “locus” refers to the vicinity, area, or place in which the plants are growing, where plant propagation materials of the plants are sown, and/or where the plant propagation materials of the plants will be placed into soil.

As used herein, the term “plant propagation material” is understood to refer to all of the generative parts of a plant, such as seeds, vegetative material such as cuttings or tubers, roots, fruits, tubers, bulbs, rhizomes, and other parts of plants, germinated plants, and/or young plants which are to be transplanted after germination or after emergence from the soil. These young plants may be protected prior to transplantation by a total or partial immersion treatment/system.

As used herein, the term “seed” embraces seeds and plant propagules of all kinds including but not limited to true seeds, seed pieces, suckers, corms, bulbs, fruit, tubers, grains, cuttings, cut shoots and the like.

As used herein, the term “g ai/L” as used herein denotes the concentration of the respective active ingredient in “grams” present “per litre” of the composition.

As used herein, the term “g ai/h” as used herein denotes the amount of the respective active ingredient in “grams” applied “per hectare” of the crop field or of the tree plantation.

As used herein, the term “kg ai/h” as used herein denotes the amount of the respective active ingredient in “kilograms” applied “per hectare” of the crop field or of the tree plantation.

In an embodiment, the additional fungicide is a systemic fungicide. As used herein, the term “systemic fungicide” refers to a fungicide which is absorbed by the foliage and roots and translocated upward internally by the plant through the xylem.

The present inventors have found that a safener comprising a zinc salt of a nitrogen containing compound for reducing phytotoxicity of systemic fungicides, namely triazole fungicides, wherein the concentration of zinc is ranging from 5% to 30% by weight of the nitrogen containing compound. Particularly, the present inventors have surprisingly found that a zinc salt of ethylenediaminetetraacetic acid (EDTA) reduces the phytotoxicity of triazole fungicides to a significant extent. The application rate of zinc EDTA was considerably less as compared to the conventional application rate of mancozeb, in the order of at least 10 times lesser.

The conventionally used micronutrient applied in phytotoxicity reduction is mancozeb which is generally applied in amounts ranging from 100 g ai/ha to 2000 g ai/ha, with 20% to 35% phytotoxicity or damage observed to crops. The present inventors have provided an alternate safener in amounts ranging from 50 g ai/ha to 200 g ai/ha which reduces plant damage to 5% to 10%.

The present disclosure provides a safener comprising a zinc salt of a nitrogen containing compound for reducing phytotoxicity of triazole fungicides in crops.

In an aspect, the zinc salt of a nitrogen containing compound is an agrochemical.

In another aspect, the agrochemical is a chelating compound.

In an embodiment, the present disclosure provides a safener comprising a zinc salt of a nitrogen containing compound for reducing phytotoxicity of triazole fungicides, wherein the concentration of zinc is ranging from 5% to 30% by weight of the nitrogen containing compound.

In an embodiment, the present disclosure provides a safener comprising a zinc salt of a nitrogen containing compound for reducing phytotoxicity of triazole fungicides, wherein the concentration of zinc is ranging from 10% to 20% by weight of the nitrogen containing compound.

In an embodiment, the present disclosure provides a safener comprising a zinc salt of a nitrogen containing compound for reducing phytotoxicity of triazole fungicides, wherein the concentration of zinc is ranging from 10% to 15% by weight of the nitrogen containing compound.

In an embodiment, the zinc salt of a nitrogen containing compound is an agrochemical.

In an embodiment, the agrochemical is a chelating compound.

In an embodiment, the Zinc salt is water soluble at pH ranging from 3 to 10.

In an embodiment, the chelating compound is a zinc salt of ethylenediaminetetraacetic acid (EDTA).

In an embodiment, the present disclosure provides a safener comprising a zinc salt of ethylenediaminetetraacetic acid (EDTA) for reducing phytotoxicity of triazole fungicides, wherein the concentration of zinc is ranging from 5% to 30% by weight of the nitrogen containing compound.

In an embodiment, the present disclosure provides a safener comprising a zinc salt of ethylenediaminetetraacetic acid (EDTA) for reducing phytotoxicity of triazole fungicides, wherein the concentration of zinc is ranging from 10% to 20% by weight of the nitrogen containing compound.

In a preferred embodiment, the present disclosure provides a safener comprising a zinc salt of ethylenediaminetetraacetic acid (EDTA) for reducing phytotoxicity of triazole fungicides, wherein the concentration of zinc is ranging from 10% to 15% by weight of the nitrogen containing compound.

In a preferred embodiment, the present disclosure provides a safener comprising a zinc salt of ethylenediaminetetraacetic acid (EDTA) for reducing phytotoxicity of triazole fungicides, wherein the concentration of zinc is 15% by weight of the nitrogen containing compound.

In an embodiment, the present disclosure provides an agrochemical combination comprising a zinc salt of a nitrogen containing compound and a triazole fungicide.

In an embodiment, the present disclosure provides an agrochemical combination comprising a zinc salt of a chelating agent and a triazole fungicide.

In an embodiment, the present disclosure provides an agrochemical combination comprising a zinc salt of ethylenediaminetetraacetic acid (EDTA) and a triazole fungicide.

In an embodiment, the present disclosure provides an agrochemical combination comprising a zinc salt of a triazole fungicide.

In an embodiment, the triazole fungicides are one or more fungicides selected from the group comprising prothioconazole, azaconazole, bitertanol, bromuconazole, cyproconazole, difenoconazole, diniconazole, enilconazole, epoxiconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimenol, triadimefon and triticonazole, or salts or adducts thereof.

In an embodiment, the present disclosure provides an agrochemical combination comprising a zinc salt of a nitrogen containing compound and prothioconazole.

In an embodiment, the present disclosure provides an agrochemical combination comprising a zinc salt of a chelating agent and prothioconazole.

In an embodiment, the present disclosure provides an agrochemical combination comprising a zinc salt of ethylenediaminetetraacetic acid (EDTA) and prothioconazole.

In an embodiment, the herbicidal combination comprises an additional agrochemical comprises at least one pesticide selected from the group comprising acaricides, algicides, avicides/bird repellents, bactericides, fungicides, herbicide safeners, herbicides, insect attractants, insect chemosterilants, insect repellents, insecticides, mammal repellents, molluscicides, nematicides, nitrification inhibitors, plant activators, plant growth regulators, rodenticides, synergists, virucides, and combinations thereof.

In a preferred embodiment, the additional fungicide is a systemic fungicide.

In an embodiment, the systemic fungicides which are particularly suitable for use in a combination according to the present invention belong to the following groups: acylalanines (metalaxyl, metalaxyl-M), benzimidazoles (benomyl, carbendazim, thiabandazole or thiophanate methyl), oxanthiins (carboxin or oxycarboxyn), organophosphates (fosctyl-Al), pyrimidines (dimethirimol, ethirimol, bupirimate, fenarimol, cyprodinil or nuarimol), triazoles (-conazoles or imidazoles-such as triadimefon, bitertanol, difenoconazole, propiconazole, myclobutanil, cyproconazole, prochloraze, bromuconazole, epoxiconazole, metconazole or tebuconazole), strobilurins (Qol fungicides, azoxystrobin, trifloxystrobin, pyraclostrobin, dimoxystrobin or kresoxim methyl), triazolinthiones (prothioconazole), succinate dehydrogenase inhibitor (SDHI) fungicides (benzovindiflupyr, bixafen, boscalid, carboxin, fluaxapyroxad, fluopyram, isopyrazam, penthiopyrador sedaxanc), piperidines (fenpropidin), organochlorine (chlorothalonil), morpholine analogue fungicides (fenpropimorph, fenpropidin or amorolfine), sulphur fungicide, or a combination of any thereof.

In an embodiment, the present disclosure provides an agrochemical combination comprising a zinc salt of a nitrogen containing compound and one or more triazole fungicide in a ratio ranging from about 0.1:10 to about 10:0.1.

In an embodiment, the present disclosure provides an agrochemical combination comprising a zinc salt of a nitrogen containing compound and one or more triazole fungicide in a ratio ranging from about 1:3 to about 3:1.

In an embodiment, the present disclosure provides an agrochemical combination comprising a zinc salt of a nitrogen containing compound and a triazole fungicide in a ratio ranging from about 0.1:5 to about 5:0.1.

In an embodiment, the present disclosure provides an agrochemical combination comprising a zinc salt of a nitrogen containing compound and a triazole fungicide in a ratio ranging from about 1:3 to about 3:1.

In an embodiment, the present disclosure provides an agrochemical combination comprising a zinc salt of a chelating agent and a triazole fungicide in a ratio ranging from about 0.1:5 to about 5:0.1.

In an embodiment, the present disclosure provides an agrochemical combination comprising a zinc salt of a chelating agent and a triazole fungicide in a ratio ranging from about 1:3 to about 3:1.

In an embodiment, the present disclosure provides an agrochemical combination comprising a zinc salt of ethylenediaminetetraacetic acid (EDTA) and a triazole fungicide in a ratio ranging from about 0.1:5 to about 5:0.1.

In an embodiment, the present disclosure provides an agrochemical combination comprising a zinc salt of ethylenediaminetetraacetic acid (EDTA) and a triazole fungicide in a ratio ranging from about 1:3 to about 3:1.

In a preferred embodiment, the present disclosure provides an agrochemical combination comprising a zinc salt of ethylenediaminetetraacetic acid (EDTA) and one or more triazole fungicides in a ratio of 0.8:1.

In a preferred embodiment, the present disclosure provides an agrochemical combination comprising a zinc salt of ethylenediaminetetraacetic acid (EDTA) and one or more triazole fungicides in a ratio of 1:1.

In a preferred embodiment, the present disclosure provides an agrochemical combination comprising a zinc salt of ethylenediaminetetraacetic acid (EDTA) and one or more triazole fungicides in a ratio of 1:2.

In a preferred embodiment, the present disclosure provides an agrochemical combination a zinc salt of ethylenediaminetetraacetic acid (EDTA) and one or more triazole fungicides in a ratio of 1:5.

In an embodiment, the present disclosure provides an agrochemical combination comprising a zinc salt of a nitrogen containing compound and prothioconazole in a ratio ranging from about 0.1:5 to about 5:0.1.

In an embodiment, the present disclosure provides an agrochemical combination comprising a zinc salt of a nitrogen containing compound and prothioconazole in a ratio ranging from about 1:3 to about 3:1.

In an embodiment, the present disclosure provides an agrochemical combination comprising a zinc salt of a chelating agent and prothioconazole in a ratio ranging from about 0.1:5 to about 5:0.1.

In an embodiment, the present disclosure provides an agrochemical combination comprising a zinc salt of a chelating agent and prothioconazole in a ratio ranging from about 1:3 to about 3:1.

In an embodiment, the present disclosure provides an agrochemical combination comprising a zinc salt of ethylenediaminetetraacetic acid (EDTA) and prothioconazole in a ratio ranging from about 0.1:5 to about 5:0.1.

In an embodiment, the present disclosure provides an agrochemical combination comprising a zinc salt of ethylenediaminetetraacetic acid (EDTA) and prothioconazole in a ratio ranging from about 1:3 to about 3:1.

In another embodiment, the present disclosure provides a method for reducing phytotoxicity of triazoles at a locus of a plant or a plant part or a plant propagation material, the method comprising applying concurrently, prior or subsequently, sequentially a zinc salt of a nitrogen containing compound and one or more triazole fungicides.

In another embodiment, the present disclosure provides a method for reducing phytotoxicity of triazoles at a locus of a plant or a plant part or a plant propagation material, the method comprising applying concurrently, prior or subsequently, a zinc salt of a chelating agent and one or more triazole fungicides.

In a preferred embodiment, the present disclosure provides a method for reducing phytotoxicity of triazoles at a locus of a plant or a plant part or a plant propagation material, the method comprising applying concurrently, prior or subsequently, a zinc salt of ethylenediaminetetraacetic acid (EDTA) and one or more triazole fungicides.

In an embodiment, the present disclosure provides a method for reducing phytotoxicity of triazoles at a locus of a plant or a plant part or a plant propagation material, the method comprising applying concurrently, prior or subsequently, a zinc salt of a nitrogen containing compound and one or more triazole fungicides, wherein the zinc salt and the triazole fungicide is in a ratio ranging from about 0.1:5 to about 5:0.1.

In an embodiment, the present disclosure provides a method for reducing phytotoxicity of triazoles at a locus of a plant or a plant part or a plant propagation material, the method comprising applying concurrently, prior or subsequently, a zinc salt of a nitrogen containing compound and one or more triazole fungicides, wherein the zinc salt and the triazole fungicide is in a ratio ranging from about 1:3 to about 3:1.

In another embodiment, the present disclosure provides a method for reducing phytotoxicity of triazoles at a locus of a plant or a plant part or a plant propagation material, the method comprising applying concurrently, prior or subsequently, a zinc salt of a chelating agent and one or more triazole fungicides, wherein the zinc salt and the triazole fungicide is in a ratio ranging from about 0.1:5 to about 5:0.1.

In another embodiment, the present disclosure provides a method for reducing phytotoxicity of triazoles at a locus of a plant or a plant part or a plant propagation material, the method comprising applying concurrently, prior or subsequently, a zinc salt of a chelating agent and one or more triazole fungicides, wherein the zinc salt and the triazole fungicide is in a ratio ranging from about 1:3 to about 3:1.

In a preferred embodiment, the present disclosure provides a method for reducing phytotoxicity of triazoles at a locus of a plant or a plant part or a plant propagation material, the method comprising applying concurrently, prior or subsequently, a zinc salt of ethylenediaminetetraacetic acid (EDTA) and one or more triazole fungicides, wherein the zinc salt and the triazole fungicide is in a ratio ranging from about 0.1:5 to about 5:0.1.

In a preferred embodiment, the present disclosure provides a method for reducing phytotoxicity of triazoles at a locus of a plant or a plant part or a plant propagation material, the method comprising applying concurrently, prior or subsequently, a zinc salt of ethylenediaminetetraacetic acid (EDTA) and one or more triazole fungicides, wherein the zinc salt and the triazole fungicide is in a ratio ranging from about 1:3 to about 3:1.

In a preferred embodiment, the present disclosure provides a method for reducing phytotoxicity of triazoles at a locus of a plant or a plant part or a plant propagation material, the method comprising applying concurrently, prior or subsequently, a zinc salt of ethylenediaminetetraacetic acid (EDTA) and one or more triazole fungicides, wherein the zinc salt and the triazole fungicide is in a ratio of 0.8:1.

In a preferred embodiment, the present disclosure provides a method for reducing phytotoxicity of triazoles at a locus of a plant or a plant part or a plant propagation material, the method comprising applying concurrently, prior or subsequently, a zinc salt of ethylenediaminetetraacetic acid (EDTA) and one or more triazole fungicides, wherein the zinc salt and the triazole fungicide is in a ratio of 1:1.

In a preferred embodiment, the present disclosure provides a method for reducing phytotoxicity of triazoles at a locus of a plant or a plant part or a plant propagation material, the method comprising applying concurrently, prior or subsequently, a zinc salt of ethylenediaminetetraacetic acid (EDTA) and one or more triazole fungicides, wherein the zinc salt and the triazole fungicide is in a ratio of 1:2.

In a preferred embodiment, the present disclosure provides a method for reducing phytotoxicity of triazoles at a locus of a plant or a plant part or a plant propagation material, the method comprising applying concurrently, prior or subsequently, a zinc salt of ethylenediaminetetraacetic acid (EDTA) and one or more triazole fungicides, wherein the zinc salt and the triazole fungicide is in a ratio of 1:5.

In an embodiment, the present disclosure provides a method for reducing phytotoxicity of triazoles at a locus of a plant or a plant part or a plant propagation material, the method comprising applying concurrently, prior or subsequently, a zinc salt of a nitrogen containing compound and one or more triazole fungicides, wherein the application amount of the zinc salt is ranging from 20 g ai/ha to 210 g ai/ha and the application amount of the triazole fungicide is ranging from 50 g ai/ha to 500 g ai/ha.

In an embodiment, the present disclosure provides a method for reducing phytotoxicity of triazoles at a locus of a plant or a plant part or a plant propagation material, the method comprising applying concurrently, prior or subsequently, a zinc salt of a nitrogen containing compound and one or more triazole fungicides, wherein the application amount of the zinc salt is ranging from 50 g ai/ha to 210 g ai/ha and the application amount of the triazole fungicide is ranging from 100 g ai/ha to 250 g ai/ha.

In an embodiment, the present disclosure provides a method for reducing phytotoxicity of triazoles at a locus of a plant or a plant part or a plant propagation material, the method comprising applying concurrently, prior or subsequently, a zinc salt of a chelating agent and one or more triazole fungicides, wherein the application amount of the zinc salt is ranging from 20 g ai/ha to 210 g ai/ha and the application amount of the triazole fungicide is ranging from 50 g ai/ha to 500 g ai/ha.

In an embodiment, the present disclosure provides a method for reducing phytotoxicity of triazoles at a locus of a plant or a plant part or a plant propagation material, the method comprising applying concurrently, prior or subsequently, a zinc salt of a chelating agent and one or more triazole fungicides, wherein the application amount of the zinc salt is ranging from 50 g ai/ha to 210 g ai/ha and the application amount of the triazole fungicide is ranging from 100 g ai/ha to 250 g ai/ha.

In a preferred embodiment, the present disclosure provides a method for reducing phytotoxicity of triazoles at a locus of a plant or a plant part or a plant propagation material, the method comprising applying concurrently, prior or subsequently, a zinc salt of EDTA and one or more triazole fungicides, wherein the application amount of the zinc salt is ranging from 20 g ai/ha to 210 g ai/ha and the application amount of the triazole fungicide is ranging from 50 g ai/ha to 500 g ai/ha.

In a preferred embodiment, the present disclosure provides a method for reducing phytotoxicity of triazoles at a locus of a plant or a plant part or a plant propagation material, the method comprising applying concurrently, prior or subsequently, a zinc salt of EDTA and one or more triazole fungicides, wherein the application amount of the zinc salt is ranging from 50 g ai/ha to 210 g ai/ha and the application amount of the triazole fungicide is ranging from 100 g ai/ha to 250 g ai/ha.

In an embodiment, the triazole fungicides are one or more fungicides selected from the group comprising prothioconazole, azaconazole, bitertanol, bromuconazole, cyproconazole, difenoconazole, diniconazole, enilconazole, epoxiconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimenol, triadimefon and triticonazole, or salts or adducts thereof.

In an embodiment, the present disclosure provides a method for reducing phytotoxicity of triazoles at a locus of a plant or a plant part or a plant propagation material, the method comprising applying concurrently, prior or subsequently, a zinc salt of a nitrogen containing compound and prothioconazole.

In an embodiment, the present disclosure provides a method for reducing phytotoxicity of triazoles at a locus of a plant or a plant part or a plant propagation material, the method comprising applying concurrently, prior or subsequently, a zinc salt of a chelating compound and prothioconazole.

In a preferred embodiment, the present disclosure provides a method for reducing phytotoxicity of triazoles at a locus of a plant or a plant part or a plant propagation material, the method comprising applying concurrently, prior or subsequently, a zinc salt of ethylenediaminetetraacetic acid (EDTA) and prothioconazole.

According to an embodiment, the present disclosure provides a method for reducing phytotoxicity in crops treated with triazole fungicides, the crops comprising rice, wheat, barley, rye, oat, sorghum, cotton, soybean, peanut, buckwheat, bect, rapeseed, sunflower, durum wheat, fall wheat, field corn, winter barley, cotton, fall barley, fallow, spring wheat, triticale, winter wheat, sugar cane, tobacco, etc.; vegetables; solanaceous vegetables such as eggplant, tomato, pimento, popper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraccous vegetables such as burdock, crown daisy, artichoke, lettuce, etc., liliaceous vegetables such as green onion, onion, garlic, and asparagus, ammiaceous vegetables such as carrot, parsley, celery, parsnip, etc., chenopodiaccous vegetables such as spinach, Swiss chard, etc., lamiaceous vegetables such as Perilla frutescens, mint, basil, etc. strawberry, sweet potato, Dioscorea japonica, colocasia, etc., flowers, foliage plants, turf grasses, fruits: pome fruits such apple, pear, quince, etc. stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees otter than fruit trees; tea, mulberry, flowering plant, trees such as ash, birch, dogwood, Eucalyptus, Ginkgo biloba, lilac, maple, Quercus, poplar, Judas tree, liquidambar formosana, plane tree, zelkova. Japanese arborvitae, fir wood, hemlock, juniper, Pinus, Picca, and Taxus cuspidate, and combinations thereof.

In a preferred embodiment, the present disclosure provides a method for controlling phytopathogenic fungi in crops treated with triazole fungicides, the crops comprising rice, wheat, barley, rye, oat, sorghum, cotton, soybean, peanut, buckwheat, beet, rapeseed, sunflower, durum wheat, fall wheat, and corn, wherein phytotoxicity in crops is reduced.

In a preferred embodiment, the present disclosure provides a method for controlling phytopathogenic fungi in soyabean crops treated with triazole fungicides, wherein crop damage is considerably reduced.

In an embodiment, the present disclosure provides use of a safener comprising a zinc salt of a nitrogen containing compound and one or more triazole fungicides for reducing phytotoxicity of triazoles.

In an embodiment, the present disclosure provides use of a safener comprising a zinc salt of a chelating agent and one or more triazole fungicides for reducing phytotoxicity of triazoles.

In a preferred embodiment, the present disclosure provides use of a safener comprising a zinc salt of ethylenediaminetetraacetic acid (EDTA) and one or more triazole fungicides for reducing phytotoxicity of triazoles.

In a preferred embodiment, the present disclosure provides use of a safener comprising a zinc salt of ethylenediaminetetraacetic acid (EDTA) and prothioconazole for reducing phytotoxicity of triazoles.

According to an embodiment of the present disclosure, the various components of the agrochemical combination can be used individually or already partially or completely mixed with one at least one other to prepare the combination according to the disclosure. It is also possible for them to be packaged and used further as composition such as a kit of parts.

The disclosure also provides a kit comprising an agrochemical combination for reducing phytotoxicity of triazole fungicides and instructions for use. The instructions for use typically comprise instructions for the application of the fungicidal combination to the plant, or to a locus, or to a plant propagation material thereof.

According to an embodiment, the kit of parts comprises:
a) zinc EDTA
b) prothioconazole, and
c) instructions for use.

According to an embodiment, the kit of parts comprises:
a) zinc EDTA
b) prothioconazole,
c) at least one agrochemically acceptable excipient; and
d) instructions for use.

In one embodiment of the disclosure, the kit may include one or more, including all, components that may be used to prepare the fungicidal combination, e.g., kits may include active ingredients and/or agrochemically acceptable excipient. One or more of the components may already be combined together or pre-formulated. In those embodiments where more than two components are provided in a kit, the components may already be combined together and as such are packaged in a single container such as a bottle, can, pouch, bag or canister. In other embodiments, two or more components of a kit may be packaged separately, i.e., not pre-formulated. As such, kits may include one or more separate containers such as cans, bottles, pouches, bags or canisters, each container containing a separate component for fungicidal combination.

In both forms, a component of the kit may be applied separately from or together with the further components or as a component of a combination according to the disclosure for preparing the fungicidal combination according to the disclosure.

In another embodiment, the agrochemical combination described above is stable, over time and at various temperatures.

All the features described herein may be combined with any of the above aspects, in any combination.

In an embodiment, the present disclosure provides a reduction in the phytotoxicity of triazole fungicides by applying a safener comprising a zinc salt of a nitrogen, wherein the concentration of zinc is ranging from 5% to 30% by weight of the nitrogen containing compound.

In an embodiment, the present disclosure provides a reduction in the phytotoxicity of triazole fungicides by applying a safener comprising a zinc salt of a nitrogen, wherein the concentration of zinc is ranging from 10% to 20% by weight of the nitrogen containing compound.

In an embodiment, the present disclosure provides a reduction in the phytotoxicity of triazole fungicides by applying a safener comprising a zinc salt of a nitrogen, wherein the concentration of zinc is ranging from 10% to 15% by weight of the nitrogen containing compound.

In an embodiment, the present disclosure provides a reduction in the phytotoxicity of triazole fungicides in the range of 0% to 10% by applying a safener comprising a zinc salt of EDTA.

In an embodiment, the present disclosure provides a reduction in the phytotoxicity of triazole fungicides in the range of 0% to 5% by applying a safener comprising a zinc salt of EDTA.

The conventionally used mancozeb applied for phytotoxicity reduction of triazole is in amounts ranging from 100 g ai/ha to 2000 g ai/ha, with 20% to 35% phytotoxicity. The present inventors have provided an alternate safener in amounts ranging from 50 g ai/ha to 200 g ai/ha which reduces plant damage to 0% to 10%.

In view of the above, it will be seen that the several advantages of the disclosure are achieved, and other advantageous results attained. Although the present disclosure has been disclosed in full, it will be understood that numerous additional modifications and variations could be made thereto without departing from the scope of the disclosure.

The present disclosure is more particularly described in the following examples that are intended as illustration only, since numerous modifications and variations within the scope of the present disclosure will be apparent to those skilled in the art. The following examples illustrate the basic methodology and versatility of the present disclosure. It will be understood that the specification and examples are illustrative but not limitative of the present disclosure and that other embodiments within the spirit and scope of the disclosure will suggest themselves to those skilled in the art. Other embodiments can be practiced that are also within the scope of the present disclosure. The following examples illustrate the disclosure, but by no means intend to limit the scope of the invention.

### Examples

The following examples are presented to provide what is believed to be the most useful and readily understood description of procedures and conceptual aspects of this invention. The examples provided below are merely illustrative of the invention and are not intended to limit the same to disclosed embodiments. Variations and changes obvious to one skilled in the art are intended to be within the scope and nature of the invention.

### Example 1: Reduction in Phytotoxicity of Triazole Fungicides

Zinc EDTA as the safener was evaluated for prothioconazole phytotoxicity reduction in soyabean crop and was compared to mancozeb as the safener. A 480 SC (suspension concentrate) formulation of prothioconazole was used. The application amount of prothioconazole was high in an amount of 350 g ai/ha. The following table 1 provides a comparative representation of the application of zinc EDTA and that of mancozeb for reducing phytotoxicity of triazoles.

TABLE 1
Evaluation of % damage in soyabean crop using safener

| Treatment | | Safener | | |
|---|---|---|---|---|
| no. | Active (g ai/ha) | (g ai/ha) | | |
| | | Zn chelate | | % |
| | Prothioconazole | (Zinc EDTA) | Ratio | Damage |
| 1. | 350 | 67 | 5:1 | 15 |
| 2. | 350 | 202 | 1.7:1 | 10 |
| | Prothioconazole | Mancozeb | Ratio | % Damage |
| 3. | 350 | 560 | 1:1.6 | 32.5 |
| 4. | 350 | 1120 | 1:3.2 | 21.7 |
| 5. | 350 | 1680 | 1:4.8 | 19.2 |
| | | Manganese | | |
| | Prothioconazole | chelate | | |
| 6. | 350 | 56.5 | 6.1:1 | 22.5 |
| 7. | 350 | 113 | 3:1 | 31.7 |

It is evident from Table 1 that the content of zinc EDTA is comparatively lesser than prothioconazole, however, the damage to crop was significantly lesser.

### Example 2: Reduction in Phytotoxicity of Triazole Fungicides

Zinc EDTA as the safener was evaluated for prothioconazole phytotoxicity reduction in soyabean crop and was compared to mancozeb as the safener. A 480 SC (suspension concentrate) formulation of prothioconazole was used. The application amount of prothioconazole was lower in an amount of 175 g ai/ha. The following table 2 provides a comparative representation of the application of zinc EDTA and that of mancozeb.

TABLE 2
Evaluation of % damage in soyabean crop using safener

| Treatment | | | | |
|---|---|---|---|---|
| no. | Active (g ai/ha) | Safener (g ai/ha) | | |
| | Prothioconazole | Zn chelate (Zinc | | % |
| | (g ai/ha) | EDTA) (g ai/ha) | Ratio | Damage |
| 1. | 175 | 67 | 2:1 | 5.0 |
| 2. | 175 | 202 | 1:0.8 | 7.0 |
| | Prothioconazole | Mancozeb | | % |
| | (g ai/ha) | (g ai/ha) | Ratio | Damage |
| 3. | 175 | 560 | 1:3.2 | 15.0 |
| 4. | 175 | 1120 | 1:6.4 | 18.0 |
| 5. | 175 | 1680 | 1:9.6 | 11.7 |
| | Prothioconazole | Manganese | | |
| | (g ai/ha) | chelate (g ai/ha) | | |
| 6. | 175 | 56.5 | 3:1 | 8.3 |
| 7. | 175 | 113 | 1.5:1 | 25.2 |

It is evident from Table 2 that the content of zinc EDTA is comparatively lesser than prothioconazole, however, the damage to crop was significantly lesser.

We claim:

1. A combination to reduce phytotoxicity of systemic fungicide in crops comprising:
a. at least one safener compound; and
b. at least one triazole fungicide;
wherein the safener comprising a zinc salt of a nitrogen containing compound.

2. The combination as claimed in claim 1, wherein the weight concentration of zinc is ranging from 5% w/w to 30% w/w of the nitrogen compound.

3. The combination as claimed in claim 1, wherein the ratio of zinc salt of nitrogen compound and at least one triazole fungicide is in the range of 0.1:10 to about 10:0.1.

4. The combination as claimed in claim 1, wherein zinc salt of nitrogen containing compound is a chelating compound.

5. The combination as claimed in claim 4, wherein the chelating compound is a zinc salt of ethylenediaminetetraacetic acid (EDTA).

6. The combination as claimed in claim 1, wherein the triazole fungicides are selected from the group comprising prothioconazole, azaconazole, bitertanol, bromuconazole, cyproconazole, difenoconazole, diniconazole, enilconazole, epoxiconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimenol, triadimefon and triticonazole, or salts or adducts thereof.

7. The combination as claimed claim 1, comprising:
a. a zinc salt of ethylenediaminetetraacetic acid (EDTA); and
b. at least one triazole fungicide.

8. A method for reducing phytotoxicity of systemic fungicides in crops by applying at a locus of a plant or a plant part or a plant propagation material a safener together with one or more triazole fungicides and an additional agrochemical.

9. The method as claimed in claim 8, wherein the safener and one or more triazole fungicides is applied as a combination or sequential or pre-mix or tank-mix.

10. The method as claimed in claim 8, wherein the safener is a zinc salt of ethylenediaminetetraacetic acid (EDTA).

11. The method as claimed in claim 8, wherein the method comprising applying a zinc salt of EDTA, wherein the weight concentration of zinc is ranging from 5% to 30% by weight of ethylenediaminetetraacetic acid (EDTA).

12. The method as claimed in claim 8, wherein the application rate of zinc salt ethylenediaminetetraacetic acid (EDTA) is ranging from 20 g ai/ha to 210 g ai/ha and the application rate of the triazole fungicide is ranging from 50 g ai/ha to 500 g ai/ha.

13. Use of a safener comprising a zinc salt of ethylenediaminetetraacetic acid (EDTA) and one or more triazole fungicides for reducing phytotoxicity of triazole fungicide.

14. A kit comprising an agrochemical combination for reducing phytotoxicity of triazole fungicides and instructions for use.

15. The kit as claimed in claim 14, comprising:
a) zinc EDTA;
b) prothioconazole;
c) at least one agrochemically acceptable excipient; and
d) instructions for use.
